(19) United States
(12) Patent Application Publication
(10) Pub. No.: US 2022/0325783 A1
(43) Pub. Date: Oct. 13, 2022

(54) DRIVE BELT TENSIONER FOR ELECTRIC VEHICLE

(71) Applicant: TAIGA MOTORS INC., Lasalle (CA)

(72) Inventors: Matthew SCHROEDER, Montréal (CA); Paul ACHARD, Lasalle (CA); Paul BRUNEAU, Lasalle (CA)

(21) Appl. No.: 17/692,649

(22) Filed: Mar. 11, 2022

Related U.S. Application Data
(60) Provisional application No. 63/173,641, filed on Apr. 12, 2021.

(51) Int. Cl. F16H 7/12; B60W 10/08; F02B 67/06; F02N 11/04; F16H 7/08

(52) U.S. Cl. CPC F16H 7/1209; B60W 10/08; F02B 67/06; F02N 11/04; F16H 7/0829; B60Y 2200/92; F16H 2007/0806; F16H 2007/0823; F16H 2007/0865; F16H 2007/0874; F16H 2007/0885; F16H 2007/0893; F16H 2007/0897

(57) ABSTRACT

An electric vehicle comprises a drive belt mounted about a motor output and about a drive wheel. The drive belt is driven by an output torque and experiences the output torque in a first torque direction and in a second torque direction. A belt tensioner comprises a tension pulley in contact with the drive belt, and a tensioning mechanism configured to displace the tension pulley in a first direction against the drive belt to tension the drive belt upon the drive belt experiencing the output torque in the first torque direction. The tensioning mechanism is configured to allow tension in the drive belt to displace the tension pulley in a second direction opposite to the first direction upon the drive belt experiencing the output torque in the second torque direction.

### CROSS-REFERENCE TO RELATED APPLICATIONS

This application claims priority to U.S. provisional patent application No. 63/173,641 filed Apr. 12, 2021, the entire contents of which are incorporated by reference herein.

### TECHNICAL FIELD

The application relates generally to electric vehicles and, more particularly, to drive belts and belt tensioners used in the transmission of such vehicles.

### BACKGROUND

A tensioner pulley may be used to maintain proper belt tension in a belt transmission assembly. By moving the tensioner pulley, the tension of the transmission belt can be adjusted.

The transmission belt on a snowmobile is intended to operate at peak efficiency when the snowmobile is moving forward. Specifically, this means that the tensioner pulley is placed on the slack side of the transmission belt where it will see minimal loads and have minimal impact on belt transmission efficiency. However, conventional tensioner pulleys are unable to respond to dynamic changes in the tension of the transmission belt.

### SUMMARY

There is disclosed an electric vehicle, comprising: an electric motor with a motor output rotatable about an output axis and configured to provide an output torque; a drive belt mounted about the motor output and about a drive wheel spaced apart from the motor output, the drive belt configured to be driven by the output torque and to experience the output torque in a first torque direction and in a second torque direction opposite to the first torque direction; and a belt tensioner comprising a tension pulley in contact with the drive belt to be rotated thereby about a tension pulley axis, and a tensioning mechanism configured to displace the tension pulley in a first direction against the drive belt to tension the drive belt upon the drive belt experiencing the output torque in the first torque direction, the tensioning mechanism configured to allow tension in the drive belt to displace the tension pulley in a second direction opposite to the first direction upon the drive belt experiencing the output torque in the second torque direction.

There is disclosed a belt tensioner, comprising: a tension pulley for contacting a drive belt and to be rotated thereby about a tension pulley axis, and a tensioning mechanism configured to displace the tension pulley in a first direction against the drive belt to tension the drive belt, the tensioning mechanism configured to allow tension in the drive belt to displace the tension pulley in a second direction opposite to the first direction.

There is disclosed an electric vehicle transmission to be driven by a motor output from an electric motor, the electric vehicle transmission comprising: a drive belt mounted about the motor output and about a drive wheel spaced apart from the motor output; and a belt tensioner comprising a tension pulley in contact with the drive belt to be rotated thereby about a tension pulley axis, and a tensioning mechanism configured to displace the tension pulley in a first direction against the drive belt to tension the drive belt upon the drive belt experiencing an output torque of the motor output in a first torque direction, the tensioning mechanism configured to allow tension in the drive belt to displace the tension pulley in a second direction opposite to the first direction upon the drive belt experiencing the output torque in a second torque direction opposite to the first torque direction.

There is disclosed a method of tensioning a drive belt mounted about an electric motor output and about a drive wheel, the method comprising: displacing a tension pulley in a first direction against the drive belt to tension the drive belt when the drive belt experiences a torque outputted by the electric motor output in a first torque direction; and displacing the tension pulley with the drive belt in a second direction opposite to the first direction when the torque experienced by the drive belt is in a second torque direction opposite to the first torque direction.

There is disclosed a method of installing a belt tensioner for a drive belt mounted about an electric motor output and about a drive wheel, the method comprising: positioning a tension pulley against the drive belt; configuring the tension pulley to displace against the drive belt in a first direction to tension the drive belt when a torque outputted by the electric motor output is experienced by the drive belt in a first torque direction; and configuring the tension pulley to be displaced by the drive belt in a second direction opposite to the first direction when the torque is experienced by the drive belt in a second torque direction opposite to the first torque direction.

### DESCRIPTION OF THE DRAWINGS

Reference is now made to the accompanying figures in which:

FIG. 1 is a schematic representation of an electric snowmobile;

FIG. 2A is a perspective view of a transmission for the electric snowmobile of FIG. 1;

FIG. 2B is a side elevational view of the transmission of FIG. 2A showing a belt tensioner;

FIG. 3A is a schematic representation of the belt tensioner of FIG. 2A under one operating condition of the electric snowmobile;

FIG. 3B is another schematic representation of the belt tensioner of FIG. 2A under another operating condition of the electric snowmobile;

FIG. 4A is a schematic representation of another belt tensioner of the transmission of FIG. 2A;

FIG. 4B is a side elevational view of the belt tensioner of FIG. 4A;

FIG. 5A is a schematic representation of another belt tensioner of the transmission of FIG. 2A showing a drive belt in a first state;

FIG. 5B is a schematic representation of the belt tensioner of FIG. 5A showing the drive belt in a transition state;

FIG. 5C is a schematic representation of the belt tensioner of FIG. 5A showing the drive belt in a second state;

FIG. 6 is a schematic illustration of a method of tensioning a drive belt; and

FIG. 7 is a schematic illustration of a method of installing a belt tensioner for a drive belt.

### DETAILED DESCRIPTION

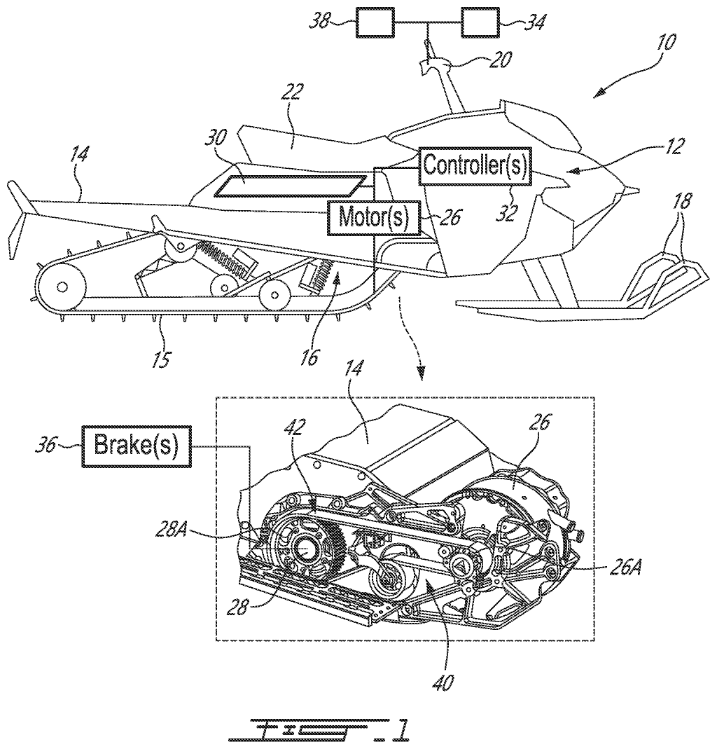

FIG. 1 is a schematic representation of an exemplary electric vehicle. The electric vehicle shown in FIG. 1 is an electric snowmobile 10. It is understood that the systems and devices described herein may also be used on other types of electric vehicles such as electric (e.g., side-by-side) utility task vehicles, electric off-road vehicles, and other electric powersport vehicles. In some embodiments, the electric snowmobile 10 includes elements of the snow vehicle described in International Patent Application no. WO 2019/049109 A1 entitled “Battery arrangement for electric snow vehicles”, the entirety of which is incorporated herein by reference.

The electric snowmobile 10 may include a frame (also known as a chassis) which may include a tunnel 14, a drive track 15 having the form of an endless belt for engaging the ground and disposed under the tunnel 14, a powertrain 16 mounted to the frame and configured to displace the drive track 15, left and right skis 18 disposed in a front portion of the electric snowmobile 10, a straddle seat 22 disposed above the tunnel 14 for accommodating an operator of the electric snowmobile 10 and optionally one or more passengers. Skis 18 may be movably attached to the frame to permit steering of vehicle 10 via a steering assembly including a steering column connected to handlebar 20.

The powertrain 16 of the electric snowmobile 10 includes one or more electric motors 26 (referred hereinafter in the singular) drivingly coupled to the drive track 15 via a drive shaft 28. The drive shaft 28 may be drivingly coupled to the drive track 15 via one or more toothed wheels or other means so as to transfer motive power from the electric motor 26 to the drive track 15. The powertrain 16 may also include one or more batteries 30 (referred hereinafter in the singular) for providing electric current to the electric motor 26 and driving the electric motor 26. The operation of the electric motor 26 and the delivery of drive current to the electric motor 26 may be controlled by a controller 32 based on an actuation of an accelerator 34, sometimes referred to as a “throttle”, by the operator. In some embodiments, the battery 30 may be a lithium ion or other type of battery 30. In various embodiments, the electric motor 26 may be a permanent magnet synchronous motor or a brushless direct current motor for example.

The electric snowmobile 10 may also include one or more brakes 36 (referred hereinafter in the singular) that may be applied or released by an actuation of a brake actuator (e.g., lever) 38 by the operator for example. The brake 36 may be operable as a main brake for the purpose of slowing and stopping the electric snowmobile 10 during motion of the electric snowmobile 10. The brake 36 may comprise a combination of tractive braking and regenerative braking. In some embodiments, the brake 36 may be operable as described in U.S. patent application Ser. No. 17/091,712 entitled “Braking system for an off-road vehicle”, the entirety of which is incorporated herein by reference. Alternatively or in addition, the brake 36 may be operable as a parking brake, sometimes called “e-brake” or “emergency brake”, of the electric snowmobile 10 intended to be used when the electric snowmobile 10 is stationary. In various embodiments, such main and parking brake functions may use separate brakes, or may use a common brake 36.

In some embodiments of tractive braking, the brake actuator 38 may be lockable when the brake 36 is applied in order to use the brake 36 as a parking brake. The brake 36 may be electrically or hydraulically operated. For example, the brake 36 may include a master cylinder operatively coupled to a brake caliper that applies brake pads against a brake rotor that is coupled to the powertrain 16. In some embodiments, such brake rotor may be secured to and rotatable with the drive shaft 28.

In some embodiments of regenerative braking shown in FIG. 1, the brake 36 is electrically connected to the battery 30. The brake 36 is a regenerative brake 36, or applies regenerative braking, such that the brake 36 or components thereof are able to supply the battery 30 with electric energy when the brake 36 is applied to a component of the powertrain 16, and/or when the operator releases the accelerator 34.

The electric motor 26 is in torque-transmitting engagement with the drive shaft 28 via a transmission 40. The transmission 40 may be of a belt/pulley type, a chain/sprocket type, or a shaft/gear type for example. Referring to FIG. 1, the transmission 40 is of a belt/pulley type. The transmission 40 includes a drive belt 42 that is mounted about a motor output 26A of the electric motor 26, and is also mounted about a drive wheel 28A for driving the drive shaft 28. The drive belt 42 therefore extends between the motor output 26A and the drive wheel 28A for conveying torque from the electric motor 26 to the drive shaft 28. The drive belt 42 is thus displaced or driven by the motor output 26A in a linear manner between the motor output 26A and the drive wheel 28A, and in a circumferential manner about the motor output 26A and the drive wheel 28A.

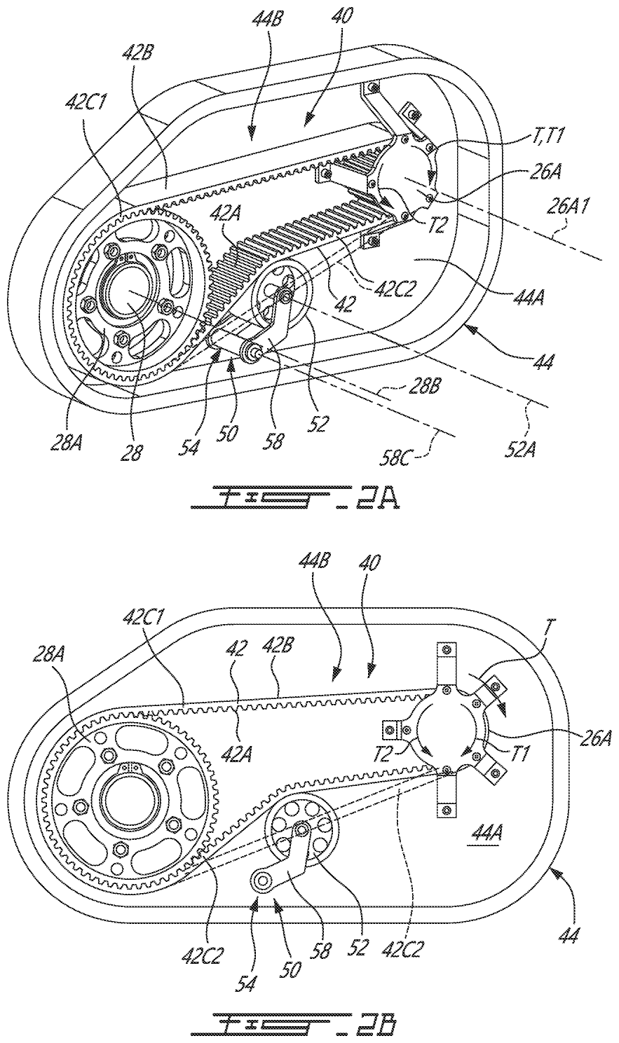

Referring to FIG. 2A, the drive wheel 28A rotates with the drive shaft 28 about a drive shaft axis 28B. The motor output 26A may have any suitable configuration to achieve such functionality. For example, and referring to FIG. 2A, the motor output 26A is a wheel or shaft that is rotatable about a motor output axis 26A1 and which engages the drive belt 42 with minimal or no slip therebetween. The motor output 26A may have any suitable feature, such as teeth, lugs, etc., which facilitates engagement with the drive belt 42. The drive belt 42 may have any suitable configuration to achieve the functionality ascribed to it herein. For example, and referring to FIG. 2A, the drive belt 42 is an elastomer that has a ribbed or toothed inner side 42A defining an inner surface of the drive belt 42 for engaging the motor output 26A and the drive wheel 28A, and a smooth or flat outer side 42B defining an outer surface of the drive belt 42. In one possible configuration, the drive belt 42 is a carbon-fiber reinforced elastomer. In another possible configuration, the drive belt 42 is a chain belt or chain which is engaged and driven by teeth of the motor output 26A and the drive wheel 28A. The drive belt 42 is thus used to transmit power from the motor output 26A. The drive belt 42 provides tractive force to the electric snowmobile 10 and transfers mechanical energy from the electric motor 26 to the drive wheel 28A. In an embodiment, the drive belt 42 is not a serpentine belt, where the serpentine belt functions to power motor auxiliaries or a supercharger.

In the embodiment of the powertrain 16 shown in FIG. 1, the electric motor 26 and the drive shaft 28 are horizontally spaced apart from each other. The drive shaft axis 28B and the motor output axis 26A1 are also horizontally spaced apart from each other and are parallel to each other. In FIGS. 2A and 2B, the electric motor 26 and the drive shaft 28 are horizontally spaced apart from each other along the length of the electric snowmobile 10. In such a horizontal orientation of the drive train 16, the drive shaft axis 28B and the motor output axis 26A1 are also horizontally spaced apart from each other and are parallel to each other. The drive train 16 may also have any other suitable orientation to displace the drive track 15. For example, in another embodiment of the powertrain 16, the electric motor 26 and the drive shaft 28 are vertically spaced apart from each other.

FIGS. 2A and 2B show a transmission housing 44 which is part of the frame of the electric snowmobile 10. The transmission housing 44 is an object or body which houses the transmission 40 and/or other components of the powertrain 16. The transmission housing 44 may have any suitable configuration to achieve this functionality. For example, and referring to FIGS. 2A and 2B, the transmission housing 44 includes a wall 44A which defines part of a partially or fully enclosed interior 44B of the transmission housing 44. The motor output 26A is disposed in the interior 44B and is rotatably mounted to the wall 44A with bearings or the like. The drive wheel 28A and part of the drive shaft 28 are disposed in the interior 44B, and are rotatably mounted to the wall 44A with bearings or the like. The drive belt 42 is disposed in the interior 44B of the transmission housing 44 and mounted about the motor output 26A and about the drive wheel 28A. The motor output 26A and the drive wheel 28A are horizontally spaced apart from each other along the length of the transmission housing 44.

Referring to FIGS. 2A and 2B, the electric motor 26 and its motor output 26A generate, produce, or output a torque T. The drive belt 42 is driven by the torque T, and transmits the torque T to the drive wheel 28A in order to rotate the drive shaft 28 about the drive shaft axis 28B and displace the drive track 15. The torque T generated by the electric motor 26 is thus experienced by the drive belt 42. Depending on the forces encountered by the drive track 15 and the powertrain 16, the drive belt 42 will experience the torque T in either a first torque direction T1 or in a second torque direction T2 that is opposite to the first torque direction T1.

The following is a description of possible scenarios in which the drive belt 42 may be subjected to the first and second torque directions T1,T2. In the scenario where the motor output 26A is outputting the torque T and the drive track 15 is propelling the electric snowmobile 10 in a forward direction of travel, the drive belt 42 will experience the torque T in the first torque direction T1. In the scenario where the electric snowmobile 10 is sliding backwards on an inclined surface but still oriented toward the forward direction and applying regenerative braking 36, the drive belt 42 will experience the torque T in the first torque direction T1. In the scenario where the brake 36 is applied directly against the drive shaft 28, the braking force may not get transferred to the drive belt 42, such that it may be possible for the motor output 26A to output the torque T so that the drive belt 42 experiences the torque T in the first torque direction T1 even while the electric snowmobile 10 is simultaneously braking.

The following different scenario is one where the torque T experienced by the drive belt 42 is in the opposite direction. When the operator releases the accelerator 34 or when the brake 36 is applied to a component of the powertrain 16 such that regenerative braking occurs and the battery 30 is supplied with electric energy, the electric snowmobile 10 will slow down but still move in the forward direction of travel as the motor output 26A continues to generate the torque T. In such a scenario, the torque T experienced by the drive belt 42 will reverse from the first torque direction T1 to the second torque direction T2. The reversal of the torque T to the second torque direction T2 in this scenario may be a temporary or transient event that lasts as long as deceleration occurs or as long as the brake 36 is applied. There are other scenarios where reversal of the torque T to the second torque direction T2 lasts longer. One example of such a scenario is when the torque T outputted by the motor output 26A is reversed in order to displace the drive belt 42 in an opposite direction so that the drive shaft 28 displaces the drive track 15 to propel the electric snowmobile 10 in a rear or backwards direction of travel. Another example where the reversal of the torque T to the second torque direction T2 lasts longer occurs when the electric snowmobile 10 is moving forward downhill and applying regenerative braking 36. It will thus be appreciated that the first and second torque directions T1,T2 experienced by the drive belt 42 are not necessarily indicative of the direction of displacement of the drive belt 42 itself. For example, the drive belt 42 can experience the torque T in the second torque direction T2 even when the drive belt 42 is displacing in a direction to move the electric vehicle 10 in the forward direction of travel.

Referring to FIGS. 2A and 2B, the engagement of the drive wheel 28A and the motor output 26A divide the drive belt 42 into a first segment 42C1 and a second segment 42C2. The first and second segments 42C1,42C2 are substantially linear portions of the drive belt 42 each of which extends between the drive wheel 28A and the motor output 26A. The first segment 42C1 extends between tangential portions of the drive wheel 28A and the motor output 26A on one radial side of the drive wheel 28A and the motor output 26A, and the second segment 42C2 extends between tangential portions of the drive wheel 28A and the motor output 26A on another, opposite radial side of the drive wheel 28A and the motor output 26A. The first and second segments 42C1,42C2 exclude the portions of the drive belt 42 that are wrapped around the drive wheel 28A and the motor output 26A at any given moment. The first and second segments 42C1,42C2 are spaced apart from each other at each of their ends by the diameters of the drive wheel 28A and the motor output 26A

The first and second segments 42C1,42C2 of the drive belt 42 alternate as “slack” or “taught” portions of the drive belt 42 depending on the torque direction T1,T2. For example, and as shown in FIGS. 2A and 2B, when the drive belt 42 is experiencing the torque T in the first torque direction T1, the first segment 42C1 may be the taught side of the drive belt 42 and the second segment 42C2 may be the slack side of the drive belt 42. When the drive belt 42 is experiencing the torque T in the second torque direction T2, the first segment 42C1 may be the slack side of the drive belt 42 and the second segment 42C2 may be the taught side of the drive belt 42 (shown in phantom lines in FIGS. 2A and 2B).

Referring to FIGS. 2A and 2B, the transmission 40 includes a belt tensioner 50 to suitably tension the drive belt 42 so that the transmission 40 operates at the optimal or desired efficiency. For example, when the second segment 42C2 is slack, it may be desirable for the belt tensioner 50 to provide tension to the drive belt 42, and when the second segment 42C2 is taught, it is desirable for the belt tensioner 50 to allow the second segment 42C2 to acquire a substantially linear path between tangential portions of the drive wheel 28A and the motor output 26A. The belt tensioner 50 is an assembly of parts or a system which functions to selectively provide tension to the drive belt 42 during displacement thereof. The belt tensioner 50 includes a tension pulley 52 engaged with the drive belt 42. The belt tensioner 50 operates to displace, and accommodate displacement, of the tension pulley 52. The belt tensioner 50 may thus be referred to as a “drive belt tightener”.

The tension pulley 52 is a driven or idler rotatable body (e.g. a wheel) that is in direct contact with the drive belt 42. The tension pulley 52 is in direct contact with the drive belt 42. The tension pulley 52 defines its own axis—the tension pulley axis 52A—and is rotated about the tension pulley axis 52A by the drive belt 42 when the drive belt 42 displaces. Referring to FIGS. 2A and 2B, the tension pulley 52 is in contact with the drive belt 42 at a location between the drive wheel 28A and the motor output 26A. The tension pulley axis 52A is parallel to the drive shaft axis 28B, and is parallel to the motor output axis 26A1. The tension pulley 52 is disposed in the interior 44B of the transmission housing 44. Referring to FIGS. 2A and 2B, the tension pulley 52 has a smooth surface in direct contact with the smooth outer side 42B of the drive belt 42. Referring to FIGS. 2A and 2B, the tension pulley 52 is in direct contact with only the outer side 42B of the drive belt 42. The transmission 40 shown in FIGS. 2A and 2B may thus be referred to as a “belt transmission”, that has a synchronous, toothed drive belt 42, and which also includes three pulleys or wheels: a toothed motor output 26A which outputs a drive of the electric motor 26, a toothed driven pulley/wheel 28A which is mounted to a drive shaft 28, and a smooth tension pulley 52 which is pressed against the outside, smooth surface of the drive belt 42 to selectively provide tension. In an alternate embodiment, the tension pulley 52 is in contact with the inner side 42A of the drive belt 42, as described in greater detail below.

Referring to FIGS. 2A and 2B, the belt tensioner 50 includes a tensioning mechanism 54 mounted to the tension pulley 52, and which functions to displace the tension pulley 52 and to accommodate displacement of the tension pulley 52. The tension pulley 52 and the tensioning mechanism 54 may be provided or packaged together to form a kit for the belt tensioner 50, or may be provided or packaged individually to be used together. The tensioning mechanism 54 is mounted to any suitable structure. Referring to FIGS. 2A and 2B, the tensioning mechanism 54 is disposed in the interior 44B of the transmission housing 44 and is mounted to the transmission housing 44. Many different configurations of the tensioning mechanism 54 are possible to achieve such functionality, and different examples of the tensioning mechanism 54 are described herein.

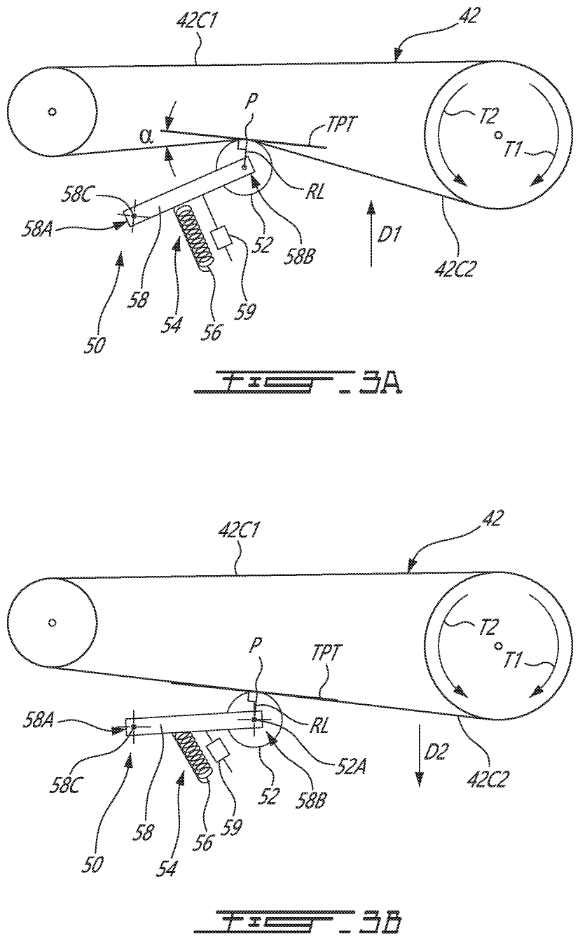

The operation of the tensioning mechanism 54 is explained in greater detail with reference to FIGS. 3A and 3B. The tensioning mechanism 54 is configured to displace the tension pulley 52 in a first direction D1 against the drive belt 42 to apply tension to the drive belt 42. The displacement of the tension pulley 52 in the first direction D1 into the drive belt 42 by the tensioning mechanism 54 creates a bend in the drive belt 42, as shown in FIG. 3A, thereby tensioning the drive belt 42. The tensioning mechanism 54 operates to tension the drive belt 42 when the torque T experienced by the drive belt 42 is in the first torque direction T1. In the configuration of the belt tensioner shown in FIGS. 3A and 3B, the second segment 42C2 of the drive belt 42 is the slack side of the drive belt 42 when the drive belt 42 is experiencing the torque T in the first torque direction T1. The displacement of the tension pulley 52 in the first direction D1 against the second segment 42C2 by the tensioning mechanism 54 reduces or eliminates the slack in the second segment 42C2 and thereby increases the tension in the drive belt 42. Thus, when the first torque direction T1 is applied to, or experienced by, the drive belt 42, the tension pulley 52 provides a tensioning bend in a slack side 42C2 of the drive belt 42. Referring to FIGS. 3A and 3B, the tension pulley 52 is in contact with only the second segment 42C2 of the drive belt 42. Referring to FIGS. 3A and 3B, the tension pulley 52 is not in contact with the first segment 42C1 of the drive belt 42. In an alternate configuration of the belt tensioner 50, the tension pulley 52 is in contact with the first segment 42C1 of the drive belt 42. In an alternate configuration of the belt tensioner 50, the tension pulley 52 includes multiple tension pulleys 52 that are in contact with both the first and second segments 42C1,42C2 of the drive belt 42, as described in greater detail below.

Referring to FIGS. 3A and 3B, the tensioning mechanism 54 is also configured to allow tension in the drive belt 42 to displace the tension pulley 52 in a second direction D2 opposite to first direction D1. In the configuration shown in FIGS. 3A and 3B, the first and second directions D1,D2 are substantially linear. By “allow” displacement of the tension pulley 52, it is understood that the tensioning mechanism 54 is sized or configured such the tension in the drive belt 42 in some circumstances will act against the tension pulley 52 to displace or push the tension pulley 52 in the direction D2. Examples of such sizing and configuring of the tensioning mechanism 54 are provided below. The displacement of the tension pulley 52 in the second direction D2 by the drive belt 42 results in the drive belt 42 being substantially straight, or substantially free of any bend therein, as shown in FIG. 3B. The tensioning mechanism 54 operates to allow displacement of the tension pulley 42 in the second direction D2 when the torque T experienced by the drive belt 42 is in the second torque direction T2. In the configuration of the belt tensioner 50 shown in FIG. 3B, the second segment 42C2 of the drive belt 42 is the taught side of the drive belt 42 when the drive belt 42 is experiencing the torque T in the second torque direction T2. Thus, when the second torque direction T2 is applied to, or experienced by, the drive belt 42, the tension in the taught side 42C2 of the drive belt 42 displaces the tension pulley 52 away from the drive belt 42. The displacement of the tension pulley 52 in the second direction D2 by the taught second segment 42C2 results in no tension being applied by the tensioning mechanism 54 and by the tension pulley 52 against the drive belt 42. The tension pulley 52 therefore does not exert any force against the drive belt 42 that might hinder or impede displacement thereof when the torque T experienced by the drive belt 42 is in the second torque direction T2. In an alternate embodiment, the tension pulley 52 applies some tension to the drive belt 42 when the torque T experienced by the drive belt 42 is in the second torque direction T2, but not of enough magnitude to hinder or impede displacement of the drive belt 42 in any significant manner.

Referring to FIG. 3A, the tension pulley 52 is driven by the tensioning mechanism 54 against the drive belt 42 to form a bend in the slack side of the drive belt 42 when the tension pulley 52 is displaced against the drive belt 42 in the first direction D1. Referring to FIG. 3B, the second segment 42C2 of the drive belt 42 is substantially flat when the second segment 42C2 becomes the taught side of the drive belt 42 when the torque T is in the second torque direction T2. By “substantially flat”, it is understood that there is no bend in the drive belt 42, or a bend that is very small in magnitude compared to the magnitude of the linear dimension of the drive belt 42. The drive belt 42 may therefore be described as being free of any bend therein when the drive belt 42 experiences the torque T in the second torque direction T2.

The flatness or straightness of the drive belt 42 when the drive belt 42 experiences the torque T in the second torque direction T2 may be better understood with reference to an angle of deflection a defined between the tension pulley 52 and the drive belt 42. Referring to FIGS. 3A and 3B, a tension pulley tangent TPT is normal to a radial line RL extending from the tangent pulley axis 52A. The tension pulley tangent TPT extends through a point of contact P of an outer circumferential surface of the tension pulley 52 with the drive belt 42. The angle of deflection a is defined between the tension pulley tangent TPT and the drive belt 42. Referring to FIG. 3B, the angle of deflection a is substantially zero when the torque T experienced by the drive belt 42 is in the second torque direction T2. By “substantially zero”, it is understood that the magnitude of the angle of deflection a is zero or a value very close to zero, such that there is no bend in the drive belt 42 formed by the tension pulley 52. It may thus be appreciated that the belt tensioner 50 helps to reduce the angle of deflection a of the drive belt 42 around the tension pulley 52 and thus helps to reduce losses in the drive belt 42 during torque reversal. When the tension pulley 52 is displaced by the tensioning mechanism 54 against the drive belt 42 to form a bend therein, as shown in FIG. 3A, the angle of deflection a has a magnitude that is greater than zero. When the tension pulley 52 is displaced by the tensioning mechanism 54 against the drive belt 42 to form a bend therein, as shown in FIG. 3A, the angle of deflection a is not zero.

In some embodiments where the electric snowmobile 10 applies regenerative braking 36 to help recharge the battery 30, the slack side and taught sides of the drive belt 42 reverse as the torque directions T1,T2 reverse. This reversal of the torque T may cause traditional tension pulleys to experience loads from the drive belt 42 that result in the tension pulley becoming an impediment to the transmission efficiency of the drive belt 42. These losses in efficiency may result in heat being generated at the tension pulley and/or drive belt 42. These losses in efficiency may also occur when the electric snowmobile 10 is moving in the reverse travel direction. The belt tensioner 50 disclosed herein helps to address these losses in efficiency by tensioning the slack side of the drive belt 42 with the tensioning mechanism 54 and the tension pulley 52 so as to optimize the transmission efficiency of the drive belt 42, and by applying no tension or little tension to the drive belt 42 by the tension pulley 52 when the torque T reverses and the slack side of the drive belt 42 becomes the taught side. The belt tensioner 50 thus allows the tension pulley 52 to respond to changes in the tension of the drive belt 42 automatically, so that the tension pulley 52 can selectively apply tension to the drive belt 42 when needed, and so that it can move out of the way when the tension in a segment 42C1,42C2 of the drive belt 42 increases, and thereby avoid becoming an impediment to the transmission efficiency of the drive belt 42. The belt tensioner 50 is thus optimized for both driving the electric snowmobile 10 in the forward direction of travel, and for regenerative braking by allowing the tension pulley 52 to move out of the way when the slack side of the drive belt 42 becomes the taught side, thereby helping to maintain efficiency and reduce energy losses in the drive belt 42.

One possible configuration of the tensioning mechanism 54 is shown with reference to FIGS. 3A and 3B. The tensioning mechanism 54 includes a biasing device or mechanism. The tensioning mechanism 54 includes a spring 56 that is engaged with the tension pulley 52. In the configuration shown in FIGS. 3A and 3B, the spring 56 is indirectly engaged with the tension pulley 52. In the configuration shown in FIGS. 3A and 3B, the spring 56 is directly mounted to a tension arm 58 of the belt tensioner 50, which is itself directly mounted to the tension pulley 52. In an alternate embodiment, the spring 56 acts directly against the tension pulley 52. During displacement of the drive belt 42, the spring 56 functions to release energy by expanding, stretching, or uncoiling in order to exert a spring force against the tension pulley 52. The spring force exerted by the spring 56 displaces the tension pulley 52 in the first direction D1 against the drive belt 42 to tension the slack segment of the drive belt 42. The spring 56 also functions to absorb energy by collapsing, coiling or winding, thereby absorbing the tension from the taught segment of the drive belt 42 and allowing the drive belt 42 to displace the tension pulley 52 in the second direction D2.

The stiffness of the spring 56 is chosen or tuned, or the spring 56 is sized, so that the tension pulley 52 provides the desired tension against the slack segment of the drive belt 42 (such as during forward motion of the electric snowmobile 10). The stiffness of the spring 56 is also chosen or tuned, or the spring 56 is also sized, so that the tension pulley 52 will displace sufficiently when the torque on the drive belt 42 reverses and the slack segment becomes the tension segment (such as during regenerative braking) so as to allow the drive belt 42 to function optimally. The spring 56 is tuned or sized so that the tension pulley 52 displaced by the drive belt 42 forms no, or very little, bend in the drive belt 42 when the torque T is in the second torque direction T2. The spring 56 may be tuned so that it satisfies the following design condition or operating parameter: minimise or eliminate the angle of deflection a between the tension pulley 52 and the drive belt 42 (i.e. make it zero if possible) as the drive belt 42 displaces around the tension pulley 52 during torque reversal. This design condition may be determined or approximated, for example, by taking the theoretical maximum output torque of the motor output 26A and dividing by the radius of the tension pulley 52 to obtain the maximum tension of the drive belt 42 that may act against the tension pulley 52. It is possible to tune the spring 56 with this tension value so that the spring 56 absorbs or accommodates movement of the tension pulley 52 to leave no bend formed in the drive belt 42 when the torque on the drive belt 42 reverses.

Referring to FIGS. 3A and 3B, the tensioning mechanism 54 thus is, or includes, a passive tensioning mechanism. For example, the spring 56 functions to tension the slack segment of the drive belt 42 as a default operating mode, and passively allows the tension pulley 52 to be displaced by the taught segment of the drive belt 42 when the torque on the drive belt 42 reverses. In an embodiment, no active control or means is required for the spring 56 to operate as described. Instead, the passive spring 56 biases the tension pulley 52 against the drive belt 42 in the default condition so as to apply sufficient spring force to tension the drive belt 42 when the torque T experienced by the drive belt 42 is in the first torque direction T1. The spring force applied by the spring 56 decreases as the tension pulley 52 is moved to its furthest position in the first direction D1. This expanded position of the spring 56 represents the position of reduced stored mechanical potential energy within the travel range of the spring 56. Then, without any active movement or control, this decreased spring force is low enough such that tension in the drive belt 42 caused by the torque T being in the second torque direction T2 is able to overcome the spring force and displace the tension pulley 52 in the second direction D2. The spring 56 therefore provides the tensioning mechanism 54 with a passive tensioning system that auto adjusts to the changing torque directions T1,T2 and tension in the drive belt 42. The spring 56 may be a coil spring (linear or non-linear), such as the one shown in FIGS. 3A and 3B. The spring 56 may be a torsion spring. The torsion-type spring 56 may allow the spring 56 to occupy a smaller volume within the transmission housing 44 and may be more suitable for packaging than a coil spring.

Depending on the anticipated oscillations caused by the torque reversal experienced by the drive belt 42, the belt tensioner 50 may include a damper 59. The damper 59 operates to dampen motion of the tensioning mechanism 54 and helps to prevent excessive oscillation of the tension pulley 52 when the tension pulley 52 is displaced by the drive belt 42. Although the damper 59 is represented schematically in FIGS. 3A and 3B as a separate component from the spring 56, the spring 56 may itself provide sufficient dampening such that the damper 59 is defined by, or is part of, the spring 56. In an embodiment, the tensioning mechanism 54 includes a torsion spring 56 in cooperation with a linear damper 59, as this configuration may optimise volume for packaging within the transmission housing 44.

Although the tensioning mechanism 54 is described as being, or including, a spring 56, the tensioning mechanism 54 may have different components or function differently than as described above. In an embodiment, the tensioning mechanism 54 includes a hydraulic, pneumatic, or electric actuator. In an embodiment, the tensioning mechanism 54 includes a Magnetorheological (MR) fluid damper or actuator. In an embodiment, the tensioning mechanism 54 includes an expandable/compressible material. Other types of tensioning mechanisms 54 are possible, and the tensioning mechanism 54 may include any one of the above examples, in any combination.

Referring to FIGS. 3A and 3B, the tension arm 58 of the belt tensioner 50 extends between a first end 58A that is pivotably mounted to a structure of the electric snowmobile 10, such as the transmission housing 44, and a second end 58B that is mounted to the tension pulley 52 to support rotatable displacement of the tension pulley 52 about the tension pulley axis 52A and relative to the tension arm 58. The mounting of the tension arm 58 at the first end 58A defines a pivot with a pivot axis 58C, such that the tension arm 58 and the tension pulley 52 move in an arc around the pivot axis 58C. The pivot axis 58C is parallel to the tension pulley axis 52A. The tensioning mechanism 54 is engaged to the tension arm 58 and acts against the tension arm 58 to displace the tension pulley 52 in the first direction D1, and to allow displacement of the tension pulley 52 by the drive belt 42 in the second direction D2. The belt tensioner 50 in the configuration shown in FIGS. 3A and 3B therefore includes a drive belt 42 engaging pulley 52 that is rotatably carried by pivoted structure for rotational movement about an axis 58C that is parallel with the tension pulley axis 52A. Although the tensioning mechanism 54 is shown in FIGS. 3A and 3B as including a coil spring 56, the tensioning mechanism 54 may alternatively include a torsional spring 56 that acts between fixed structure (e.g. portions of the transmission housing 44) and pivoted structure (e.g. the tension arm 58) for resiliently biasing the pivoted structure to move in the first direction D1 toward the drive belt 42 and apply a spring force which decreases as the tension arm 58 is moved further away from its initial position.

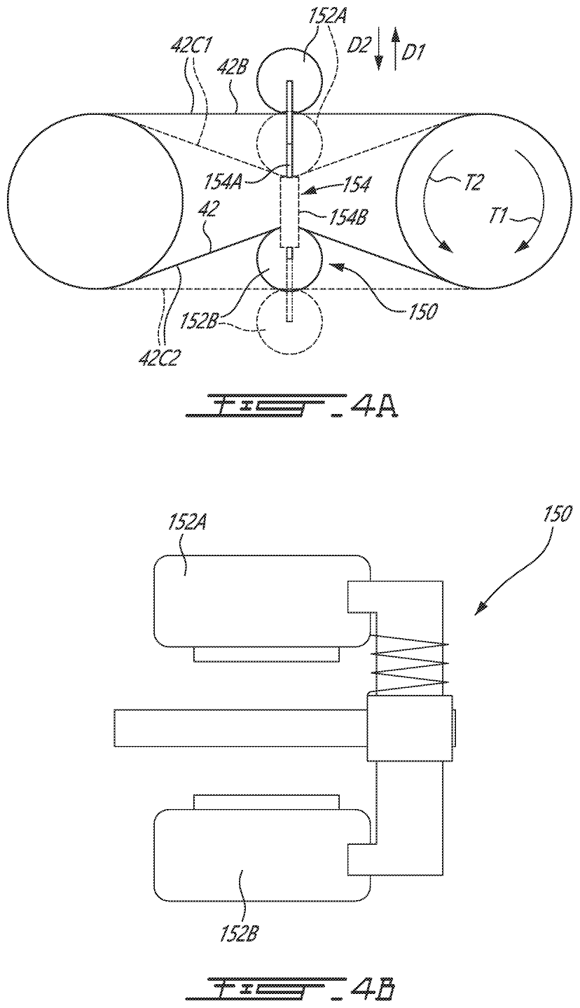

Different configurations of the tensioning mechanism 54 are possible to selectively tension the drive belt 42, as described above. Another possible configuration of the tensioning mechanism 154 and of the belt tensioner 150 is shown in FIGS. 4A and 4B. The features, advantages, functionalities and reference numbers ascribed above to the belt tensioner 50 and to the tensioning mechanism 54 apply mutatis mutandis to the belt tensioner 150 and to the tensioning mechanism 154 shown in FIGS. 4A and 4B.

Referring to FIGS. 4A and 4B, the belt tensioner 150 includes two tension pulleys—a first tension pulley 152A in contact with the first segment 42C1 of the drive belt 42 and a second tension pulley 152B in contact with the second segment 42C2 of the drive belt 42. The tensioning mechanism 154 functions to displace the first and second tension pulleys 152A,152B in the first and second directions D1,D2 against their respective segments 42C1,42C2 of the drive belt 42 to tension the first and second segments 42C1,42C2, in response to the torque T experienced by the drive belt reversing between the first and second torque directions T1,T2. This configuration of the tensioning mechanism 154 helps to ensure that there is always tension in the slack side of the drive belt 42 when the slack-taught sides reverse during torque reversal. Depending on the magnitude of the torque reversal experienced by the drive belt 42, the taught segment of the drive belt 42 may not have sufficient tension to displace a single tension pulley 52 to achieve a zero angle of deflection a or no bend in the taught segment of the drive belt 42. The use of two tension pulleys 152A,152B helps to always maintain tension in the drive belt 42 such that the taught segment of the drive belt 42 may always have sufficient tension to displace one of the tension pulleys 152A,152B to achieve no bend in the taught segment of the drive belt 42.

In the configuration of the tensioning mechanism 154 shown in FIGS. 4A and 4B, the tensioning mechanism 154 operates to displace the first and second tension pulleys 152A,152B together and simultaneously, such that the first and second tension pulleys 152A,152B both move simultaneously in the first direction D1, and in the second direction D2. The movement of one of the first and second pulleys 152A,152B is dependent on the movement of the other of the first and second pulleys 152A,152B. Each of the first and second tension pulleys 152A,152B is in contact with an outer surface defined by the outer side 42B of the drive belt 42. The tensioning mechanism 154 operates passively, similarly to as explained above, in that the tension on the first and second segments 42C1,42C2 causes the displacement of the first and second tension pulleys 152A,152B. One example of the simultaneous and coordinated displacement of the first and second tension pulleys 152A,152B is now described. When the torque T experienced by the drive belt 42 is in the first torque direction T1, the second tension pulley 152B is displaced in the first direction D1 against the second segment 42C2 of the drive belt 42 to tension the second segment 42C2, and to allow tension in the first segment 42C1 to displace the first tension pulley 152A in the first direction D1. When the torque T experienced by the drive belt 42 is in the second torque direction T2, the first tension pulley 152A is displaced in the second direction D2 against the first segment 42C1 (shown in phantom lines in FIG. 4A) to tension the first segment 42C1, and to allow tension in the second segment 42C2 to displace the second tension pulley 152B in the second direction D2 (shown in phantom lines in FIG. 4A).

The tensioning mechanism 154 may have any suitable configuration to achieve this operation of the first and second tension pulleys 152A,152B. For example, and referring to FIGS. 4A and 4B, the tensioning mechanism 154 includes a bar or rod 154A that has a fixed length, and which is mounted at each of its ends to the first and second tension pulleys 152A,152B to allow them to rotate about their axes and to displace together in the first and second directions D1,D2. The tensioning mechanism 154 includes a coil spring 154B that is mounted at one end to fixed structure, such as the transmission housing 44, and at another end to part of the rod 154A. When the electric snowmobile 10 is travelling in the forward direction of travel and the torque T experienced by the drive belt 42 is in the first torque direction T1, the first segment 42C1 is the taught segment of the drive belt 42 and displaces the first tension pulley 152A in the first direction D1, thereby displacing the rod 154A in the first direction D1. The second segment 42C2 of the drive belt 42 is the slack side and is tensioned by the second tension pulley 152B bending the second segment 42C2. The second tension pulley 152B is caused to displace in the first direction D1 by displacement of the rod 154A in the first direction D1 and the action of the spring 154B. When regenerative braking 36 is applied or the electric snowmobile 10 is travelling in the rearward direction of travel and the torque T experienced by the drive belt 42 is in the second torque direction T2, the second segment 42C2 is the taught segment of the drive belt 42 and displaces the second tension pulley 152B in the second direction D2, thereby displacing the rod 154A in the second direction D2 (shown in phantom lines in FIG. 4A). The first segment 42C1 of the drive belt 42 is the slack side, and is tensioned by the first tension pulley 152A bending the first segment 42C1 (shown in phantom lines in FIG. 4A). The first tension pulley 152A is caused to displace in the second direction D2 by displacement of the rod 154A in the second direction D2 and the action of the spring 154B. In an alternate configuration, the rod 154A is a pivot rod that is pivotably mounted to a portion of the transmission housing 44, and which is V-shaped with two rod arms each mounted to one of the first and second tension pulleys 152A,152B to permit rotation thereof.

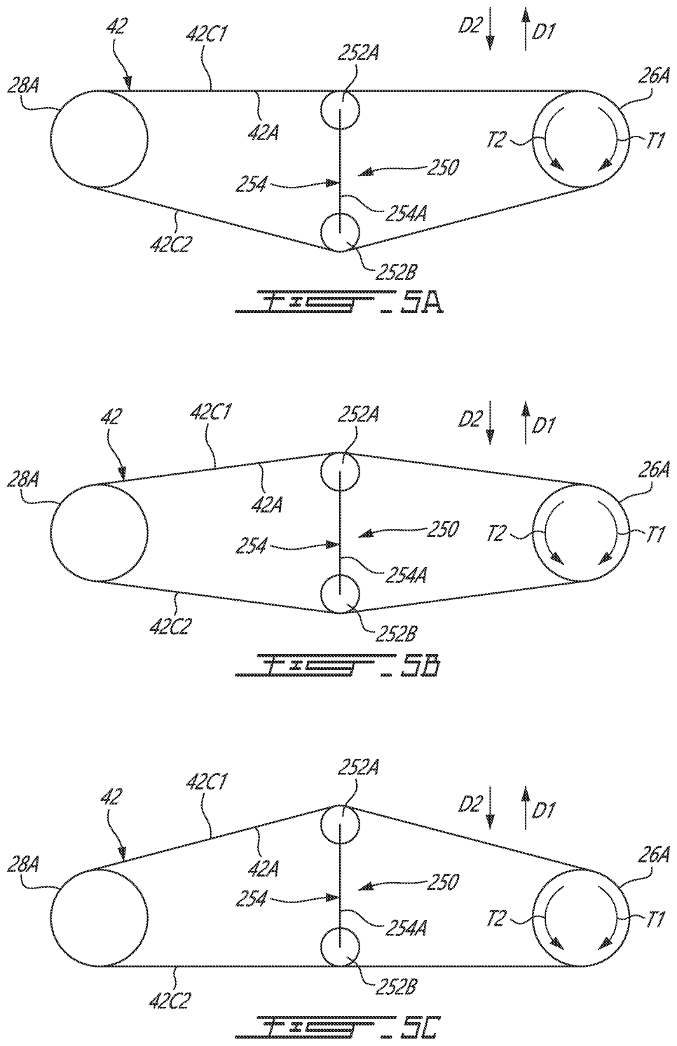

Another possible configuration of the tensioning mechanism 254 is shown in FIGS. 5A to 5C. The features, advantages, functionalities and reference numbers ascribed above to the tensioning mechanism 54,154 apply mutatis mutandis to the tensioning mechanism 254 shown in FIGS. 5A to 5C.

Referring to FIGS. 5A to 5C, the belt tensioner 250 includes two tension pulleys—a first tension pulley 252A in contact with the first segment 42C1 of the drive belt 42 and a second tension pulley 252B in contact with the second segment 42C2 of the drive belt 42. The tensioning mechanism 254 functions to displace the first and second tension pulleys 252A,252B in the first and second directions D1,D2 against their respective segments 42C1,42C2 of the drive belt 42 to tension the first and second segments 42C1,42C2, in response to the torque T experienced by the drive belt reversing between the first and second torque directions T1,T2. This configuration of the tensioning mechanism 254 helps to ensure that there is always tension in the slack side of the drive belt 42 when the slack-taught sides reverse during torque reversal. Depending on the magnitude of the torque reversal experienced by the drive belt 42, the taught segment of the drive belt 42 may not have sufficient tension to displace a single tension pulley 52 to achieve a zero angle of deflection a or no, or very little, bend in the taught segment of the drive belt 42. The use of two tension pulleys 252A,252B helps to always maintain tension in the drive belt 42 such that the taught segment of the drive belt 42 may always have sufficient tension to displace one of the tension pulleys 252A,252B to achieve no bend in the taught segment of the drive belt 42.

In the configuration of the tensioning mechanism 254 shown in FIGS. 5A to 5C, the tensioning mechanism 254 operates to displace the first and second tension pulleys 252A,252B together and simultaneously, such that the first and second tension pulleys 252A,252B both move simultaneously in the first direction D1, and in the second direction D2. The movement of one of the first and second pulleys 252A,252B is dependent on the movement of the other of the first and second pulleys 252A,252B. Each of the first and second tension pulleys 252A,252B is in contact with an inner surface defined by the inner side 42A of the drive belt 42. The tensioning mechanism 254 operates passively, similarly to as explained above, in that the tension on the first and second segments 42C1,42C2 causes the displacement of the first and second tension pulleys 252A,252B. One example of the simultaneous and coordinated displacement of the first and second tension pulleys 252A,252B is now described. When the torque T experienced by the drive belt 42 is in the first torque direction T1, as shown in FIG. 5A, the second tension pulley 252B is displaced in the second direction D2 against the second segment 42C2 of the drive belt 42 to tension the second segment 42C2, and to allow tension in the first segment 42C1 to displace the first tension pulley 252A in the second direction D2. When the torque T experienced by the drive belt 42 is in the second torque direction T2, as shown in FIG. 5C, the first tension pulley 252A is displaced in the first direction D1 against the first segment 42C1 to tension the first segment 42C1, and to allow tension in the second segment 42C2 to displace the second tension pulley 252B in the first direction D1.

The tensioning mechanism 254 may have any suitable configuration to achieve this operation of the first and second tension pulleys 252A,252B. For example, and referring to FIGS. 5A to 5C, the tensioning mechanism 254 includes a bar or rod 254A that has a fixed length, and which is mounted at each of its ends to the first and second tension pulleys 252A,252B to allow them to rotate about their axes and to displace together in the first and second directions D1,D2. When the electric snowmobile 10 is travelling in the forward direction of travel and the torque T experienced by the drive belt 42 is in the first torque direction T1, as shown in FIG. 5A, the first segment 42C1 is the taught segment of the drive belt 42 and pushes the first tension pulley 252A in the second direction D2, thereby displacing the rod 254A in the second direction D2. The second segment 42C2 of the drive belt 42 is the slack side and is tensioned by the second tension pulley 252B pushing against and bending the second segment 42C2. The second tension pulley 252B is caused to displace in the second direction D2 by displacement of the rod 254A in the second direction D2. When regenerative braking 36 is applied or the electric snowmobile 10 is travelling in the rearward direction of travel and the torque T experienced by the drive belt 42 is in the second torque direction T1, as shown in FIG. 5C, the second segment 42C2 is the taught segment of the drive belt 42 and pushes the second tension pulley 252B in the first direction D1, thereby displacing the rod 254A in the first direction D1. The first segment 42C1 of the drive belt 42 is the slack side, and is tensioned by the first tension pulley 252A pushing against and bending the first segment 42C1. The first tension pulley 252A is caused to displace in the first direction D1 by displacement of the rod 254A in the first direction D1. In an alternate configuration, the rod 254A is a pivot rod that is pivotably mounted to a portion of the transmission housing 44, and which is V-shaped with two rod arms each mounted to one of the first and second tension pulleys 252A,252B to permit rotation thereof. The tensioning mechanism 254 may include a spring mounted to the rod 254A to aid in displacing the rod 254A between the first and second directions D1,D2. FIG. 5B shows the drive belt 42 in a transient phase at the moment of transition between the first and second torque directions T1,T2. In such a transient moment, the first and second segments 42C1,42C2 of the drive belt 42 are both slack segments. In another possible configuration, the tensioning mechanism 54,154,254 operates to allow the first and second tension pulleys 152A,252A,152B,252B to displace independently of each other against their respective segments 42C1,42C2 of the drive belt 42.

Referring to FIGS. 5A to 5C, the tensioning mechanism 254 functions to displace the first and second tension pulleys 252A,252B so that they tension the respective segments 42C1,42C2 of the drive belt 42 by pushing them in an “outward” direction. The outward direction is a direction that is radially outwardly from the axes 26A1,28B of the motor output 26A and the drive wheel 28A and parallel to the first and second directions D1,D2. This “outward” bending of the first and second segments 42C1,42C2 when being tensioned results in the drive belt 42 always being tensioned in the same direction that it bends when going around the motor output 26A and the drive wheel 28A, which may contribute to the transmission efficiency and lifetime longevity of the drive belt 42.

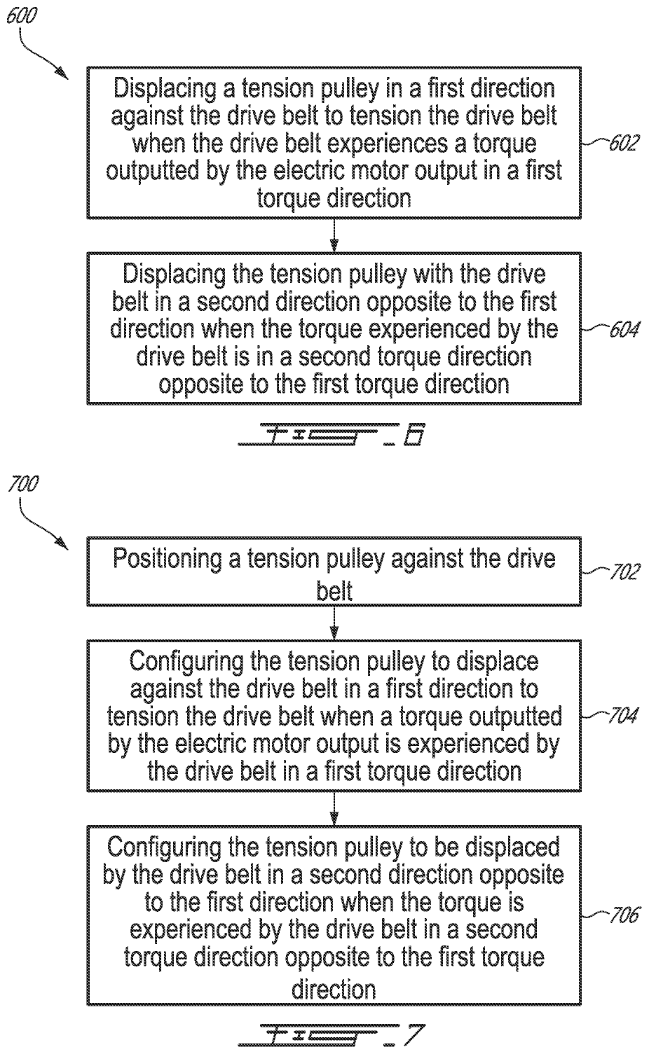

Referring to FIG. 6, there is disclosed a method 600 of tensioning the drive belt 42. At 602, the method 600 includes displacing the tension pulley 52,152A,152B,252A,252B in the first direction D1/D2 against the drive belt 42 to tension the drive belt 42 when the drive belt 42 experiences the torque T in the first torque direction T1. At 604, the method 600 includes displacing the tension pulley 52,152A,152B,252A,252B with the drive belt 42 in the second direction D2/D1 when the torque T experienced by the drive belt 42 is in the second torque direction T2.

Referring to FIG. 7, there is disclosed a method 700 of installing the belt tensioner 50,150,250. At 702, the method 700 includes positioning the tension pulley 52,152A,152B,252A,252B against the drive belt 42. At 704, the method 700 includes configuring the tension pulley 52,152A,152B,252A,252B to displace against the drive belt 42 in the first direction D1/D2 to tension the drive belt 42 when the torque T experienced by the drive belt 42 is in the first torque direction T1. At 706, the method 700 includes configuring the tension pulley 52,152A,152B,252A,252B to be displaced by the drive belt 42 in the second direction D2/D1 when the torque T is experienced by the drive belt 42 in the second torque direction T2.

The belt tensioner 50,150,250 disclosed herein helps to improve the transmission efficiency of the drive belt 42 when the electric snowmobile 10 is reversing or applying regenerative braking. The belt tensioner 50,150,250 disclosed herein helps to optimize the transmission efficiency of the drive belt 42 exposed to two torque directions T1,T2. In an embodiment, the tension pulley 52,152A,152B,252A,252B may be made relatively light since it will not have to endure or support high tension forces from the drive belt 42 when the electric snowmobile 10 is reversing or applying regenerative braking. This may enhance the life or durability of the drive belt 42.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, the belt tensioner 50,150,250 disclosed herein may be used with any vehicle 10 with a belt drive transmission that applies regenerative braking or can travel in a reverse direction. Yet further modifications could be implemented by a person of ordinary skill in the art in view of the present disclosure, which modifications would be within the scope of the present technology.

1. An electric vehicle, comprising:
an electric motor with a motor output rotatable about an output axis and configured to provide an output torque;
a drive belt mounted about the motor output and about a drive wheel spaced apart from the motor output, the drive belt configured to be driven by the output torque and to experience the output torque in a first torque direction and in a second torque direction opposite to the first torque direction; and
a belt tensioner comprising a tension pulley in contact with the drive belt to be rotated thereby about a tension pulley axis, and a tensioning mechanism configured to displace the tension pulley in a first direction against the drive belt to tension the drive belt upon the drive belt experiencing the output torque in the first torque direction, the tensioning mechanism configured to allow tension in the drive belt to displace the tension pulley in a second direction opposite to the first direction upon the drive belt experiencing the output torque in the second torque direction.

2. The electric vehicle of claim 1, wherein a tension pulley tangent is normal to a radial line extending from the tangent pulley axis, the tension pulley tangent extending through a point of contact of the tension pulley with the drive belt, an angle of deflection defined between the tension pulley tangent and the drive belt, the angle of deflection being substantially zero upon the drive belt experiencing the output torque in the second torque direction.

3. The electric vehicle of claim 1, wherein the tension pulley forms a bend in the drive belt upon the tension pulley being displaced against the drive belt, the drive belt being free of the bend upon the drive belt experiencing the output torque in the second torque direction.

4. The electric vehicle of claim 1, wherein the tension pulley applies no tension to the drive belt upon the drive belt experiencing the output torque in the second torque direction.

5. The electric vehicle of claim 1, wherein the drive belt defines an inner surface mounted about the motor output and about the drive wheel, and an outer surface, the tension pulley in contact with the outer surface of the drive belt.

6. The electric vehicle of claim 1, wherein the tensioning mechanism includes a spring engaged with the tension pulley to release energy and displace the tension pulley in the first direction, the spring configured to absorb energy and allow tension in the drive belt to displace the tension pulley in the second direction.

7. The electric vehicle of claim 6, wherein the spring engages the tension pulley to contact the drive belt and form no bend therein upon the drive belt experiencing the output torque in the second torque direction.

8. The electric vehicle of claim 6, wherein the spring is a coil spring or a torsion spring.

9. The electric vehicle of claim 1, wherein the tensioning mechanism includes a tension arm extending between a first end pivotably mounted to structure of the electric vehicle and a second end mounted to the tension pulley, the tensioning mechanism engaged with the tension arm to displace the tension pulley in the first direction, and to allow displacement of the tension pulley in the second direction.

10. The electric vehicle of claim 1, wherein the drive wheel and the motor output define a first segment of the drive belt and a second segment of the drive belt, the tension pulley in contact with only one of the first and second segments of the drive belt.

11. The electric vehicle of claim 1, wherein the tension pulley is a first tension pulley in contact with a first segment of the drive belt extending between the drive wheel and the motor output, the belt tensioner including a second tension pulley in contact with a second segment of the drive belt extending between the drive wheel and the motor output and spaced apart from the first segment, the tensioning mechanism configured to displace the first and second tension pulleys in the first and second directions against the respective first and second segments to tension the first and second segments, in response to the output torque changing between the first and second torque directions.

12. The electric vehicle of claim 1, wherein the drive wheel and the motor output define a first segment of the drive belt and a second segment of the drive belt, the tension pulley being a first tension pulley in contact with the first segment of the drive belt, the belt tensioner including a second tension pulley in contact with the second segment of the drive belt to be rotated thereby, the tensioning mechanism configured to:
displace the second tension pulley in the second direction against the second segment of the drive belt to tension the second segment of the drive belt, and to allow tension in the first segment of the drive belt to displace the first tension pulley in the second direction upon the drive belt experiencing the output torque in the first torque direction; and
displace the first tension pulley in the first direction against the first segment of the drive belt to tension the first segment of drive belt, and to allow tension in the second segment of the drive belt to displace the second tension pulley in the first direction upon the drive belt experiencing the output torque in the second torque direction.

13. The electric vehicle of claim 1, wherein the drive wheel and the motor output define a first segment of the drive belt and a second segment of the drive belt, the tension pulley being a first tension pulley in contact with an inner surface of the first segment of the drive belt, the belt tensioner including a second tension pulley in contact an inner surface with the second segment of the drive belt to be rotated thereby, the tensioning mechanism configured to:
displace the second tension pulley in the first direction against the second segment of the drive belt to tension the second segment of the drive belt, and to allow tension in the first segment of the drive belt to displace the first tension pulley in the first direction upon the drive belt experiencing the output torque in the first torque direction; and
displace the first tension pulley in the second direction against the first segment of the drive belt to tension the first segment of drive belt, and to allow tension in the second segment of the drive belt to displace the second tension pulley in the second direction upon the drive belt experiencing the output torque in the second torque direction.

14. The electric vehicle of claim 1, comprising a regenerative brake configured to supply electric energy to a battery of the electric vehicle, the drive belt configured to experience the output torque in the second torque direction upon the regenerative brake being applied and supplying electric energy to the battery.

15. The electric vehicle of claim 1, comprising a ground-engaging track, the drive wheel operable to drive the ground-engaging track.

16. A method of tensioning a drive belt mounted about an electric motor output and about a drive wheel, the method comprising:
displacing a tension pulley in a first direction against the drive belt to tension the drive belt when the drive belt experiences a torque outputted by the electric motor output in a first torque direction; and
displacing the tension pulley with the drive belt in a second direction opposite to the first direction when the torque experienced by the drive belt is in a second torque direction opposite to the first torque direction.

17. The method of claim 16, wherein displacing the tension pulley in the first direction against the drive belt includes displacing the tension pulley against an outer surface of the drive belt, and wherein displacing the tension pulley with the drive belt in the second direction includes displacing the tension pulley with the outer surface of the drive belt in the second direction.

18. The method of claim 16, wherein displacing the tension pulley in the first direction against the drive belt includes releasing energy from a biasing mechanism engaged with the tension pulley, and wherein displacing the tension pulley with the drive belt in the second direction includes absorbing energy with the biasing mechanism.

19. The method of claim 16, wherein displacing the tension pulley in the first direction includes displacing the tension pulley in the first direction against a segment of the drive belt extending between the drive wheel and the motor output, and wherein displacing the tension pulley with the drive belt in the second direction includes displacing the tension pulley with the same segment of the drive belt in the second direction.

20. The method of claim 16, comprising applying regenerative braking to a shaft of the drive wheel, the torque experienced by the drive belt being in the second torque direction.
